(19) United States
(12) Patent Application Publication
(10) Pub. No.: US 2024/0310166 A1
(43) Pub. Date: Sep. 19, 2024

(54) Laser Plumb/Pitch Pipe Alignment Device

(71) Applicant: Michael V. Goffredo, Laurel Springs, NJ (US)

(72) Inventor: Michael V. Goffredo, Laurel Springs, NJ (US)

(21) Appl. No.: 18/205,799

(22) Filed: Jun. 5, 2023

Related U.S. Application Data
(60) Provisional application No. 63/451,911, filed on Mar. 13, 2023.

(51) Int. Cl. G01B 11/27

(52) U.S. Cl. CPC G01B 11/27

(57) ABSTRACT

A laser plumb/pitch pipe alignment device provides precise continuous straight line locations for boring plumb or pitched alignment holes through studs, walls, and roofs as well as for shooting a level line for pipe/conduit work. The device can be used both horizontally and vertically for exact alignment. The device accommodates pipes of different sizes and slips on and off the pipes to direct the laser light to the area for boring to accommodate a pipe extension or for plumb alignment. Button styled level vials may be placed on top of the housing for vertical plumb use and elongated styled level vials may be set in recessed slots on the side of the housing for horizontal pitch/fall/level use. The housing includes a laser module housing for aligning a laser module to direct generated laser light out of the housing along the axis of the pipes.

### CROSS-REFERENCE TO RELATED APPLICATION

The present application claims priority to U.S. Provisional Patent Application No. 63/451,911, filed Mar. 13, 2023. The contents of that application are hereby incorporated by reference in their entirety.

### TECHNICAL FIELD

This patent application describes a laser plumb/pitch pipe alignment device for use in installation of pipes in private and commercial dwellings and, more particularly, to a plumb, pitch, fall, and/or level laser pipe alignment device that uses a laser pointer fitted over an end of a pipe for alignment.

### BACKGROUND

During installation and maintenance of plumbing pipes, vertical and horizontal measures and marks may be required to pinpoint a next drill location for drilling a hole in a joist through which a pipe must pass. For example, a conventional Plumb Bob may be used for vertical installations requiring a measuring tool to establish the distance between the point of origin, the next point, and all successive piping locations. However, the Plumb Bob is not particularly helpful for horizontal drilling locations, which typically require the user to measure and mark each affected joist. If the hole is not located in the correct position, the installation and/or maintenance may be compromised. A faster and more accurate method of determining successive pipe drilling location(s) is desired that can, for example, enable the user to make better angled positions such as when running a vent pipe through an angled roof.

### SUMMARY

Various examples are now described to introduce a selection of concepts in a simplified form that are further described below in the Detailed Description. The Summary is not intended to be used to limit the scope of the claimed subject matter.

A laser plumb/pitch pipe alignment device is provided that includes a housing adapted to fit over an end of a pipe and having a center hole aligned with a center axis of the pipe when inserted. A laser module is disposed within the housing so as to align with the center axis of the pipe. The laser module emits laser light out of the center hole for use in vertical and horizontal configurations for boring holes or plumb alignment. The housing has a first inner wall that abuts an outer surface of a pipe of a first size when inserted into the housing and a second inner wall that abuts an outer surface of a pipe of a second size, smaller than the first size, when inserted into the housing.

The laser plumb/pitch pipe alignment device may include at least one button styled level vial on an outer end of the housing for vertical plumb use and/or at least one elongated styled level vial set in a corresponding recessed slot on an outer side of the housing for horizontal pitch/fall/level use.

The housing includes a laser module housing that houses the laser module. The laser module housing has the center hole at one end thereof and a cap on another end thereof that is removable to provide access to the laser module when the laser module is housed within the laser module housing. The laser module may include a battery powered class IIIA laser module with an on/off power switch.

A method is also described for providing precise continuous straight line locations for boring plumb or pitched alignment holes through at least one of studs, walls, or roofs and for shooting a level line for pipe/conduit work. The method includes slipping a laser plumb/pitch pipe alignment device over an end of a pipe where the laser plumb/pitch pipe alignment device has a center hole aligned with a center axis of the pipe when inserted and a laser module disposed within a housing of the laser plumb/pitch pipe alignment device so as to align with the center axis of the pipe and to emit laser light out of the center hole. The emitted laser light is directed to an area for boring at least one hole to accommodate a pipe extension or for indicating a plumb line alignment point.

For a pipe of a first size (e.g., 2″ diameter), slipping the laser plumb/pitch pipe alignment device over the end of the pipe may include inserting the pipe into the housing whereby an outer surface of the pipe abuts a first inner wall of the housing when inserted. For a pipe of a second size (e.g., 1½″ diameter), slipping the laser plumb/pitch pipe alignment device over the end of the pipe may include inserting the pipe into the housing whereby an outer surface of the pipe abuts a second inner wall of the housing when inserted.

The method may further include determining a vertical plumb using at least one button styled level vial on an outer end of the housing of the laser plumb/pitch pipe alignment device and/or determining at least one of a horizontal pitch, fall, or level using at least one elongated styled level vial set in a corresponding recessed slot on an outer side of the housing of the laser plumb/pitch pipe alignment device.

The method May also include inserting a laser module into a laser module housing within the housing of the laser plumb/pitch pipe alignment device whereby the laser module aligns with the center hole to emit the laser light out of the center hole when activated. A cap may be provided on an end of the laser module housing opposite the center hole once the laser module has been inserted into the laser module housing. In a sample configuration, the laser module may include a battery powered class IIIA laser module with an on/off power switch. In such a configuration, the method further includes turning the laser module on/off using the on/off power switch.

This summary section is provided to introduce aspects of the inventive subject matter in a simplified form, with further explanation of the inventive subject matter following in the text of the detailed description. The particular combination and order of elements listed in this summary section is not intended to provide limitation to the elements of the claimed subject matter. Rather, it will be understood that this section provides summarized examples of some of the embodiments described in the Detailed Description below.

### BRIEF DESCRIPTION OF THE DRAWINGS

The foregoing and other beneficial features and advantages of the invention will become apparent from the following detailed description in connection with the attached figures, of which:

FIG. 1 is a perspective view of a laser plumb/pitch pipe alignment device in a horizontal (pitch/fall/level) position in a sample configuration.

FIG. 2 is a left side perspective view of the laser plumb/pitch pipe alignment device in a vertical (plumb) position in a sample configuration.

FIG. 3 is a right side perspective view of the laser plumb/pitch pipe alignment device in a vertical (plumb) position in a sample configuration.

FIG. 4 is a side view of the laser plumb/pitch pipe alignment device in a horizontal (pitch/fall/level) position in a sample configuration.

FIG. 5 is a top view of the laser plumb/pitch pipe alignment device in a sample configuration.

FIG. 6 is a bottom view of the laser plumb/pitch pipe alignment device in a sample configuration.

FIG. 7 is a cross-sectional view of the interior of the laser plumb/pitch pipe alignment device in a sample configuration.

FIG. 8 is a perspective view of a class IIIA laser module with an on/off power switch in a sample configuration.

FIG. 9 illustrates the laser plumb/pitch pipe alignment device mounted in a horizontal (pitch/fall/level) position on an end of a 1½″ pipe for projecting a laser beam to be used for alignment in a sample configuration.

FIG. 10 illustrates the laser plumb/pitch pipe alignment device mounted in a vertical (plumb) position on an end of a 2″ pipe for projecting a laser beam to be used for alignment in a sample configuration.

FIG. 11 illustrates a bare stud wall frame showing the laser plumb/pitch pipe alignment device in a horizontal (pitch/fall/level) position with laser beam aligning points to drill out for pipe installation in a sample configuration.

FIG. 12 illustrates a bare stud wall showing the laser plumb/pitch pipe alignment device in a vertical (plumb) position with laser beam aligning points to drill out for pipe installation through a header of the bare stud wall and all the way to the bottom side of a roof deck in a sample configuration.

### DETAILED DESCRIPTION

Embodiments of the laser plumb/pitch pipe alignment device described herein may be understood more readily by reference to the following detailed description taken in connection with the accompanying figures and examples that form a part of this disclosure. It is to be understood that this description is not limited to the specific products, methods, conditions, or parameters described and/or shown herein, and that the terminology used herein is for the purpose of describing particular embodiments by way of example only and is not intended to be limiting of any claimed subject matter. Similarly, any description as to a possible mechanism or mode of action or reason for improvement is meant to be illustrative only, and the subject matter described herein is not to be constrained by the correctness or incorrectness of any such suggested mechanism or mode of action or reason for improvement. Throughout this text, it is recognized that the descriptions refer both to methods and systems for implementing such methods.

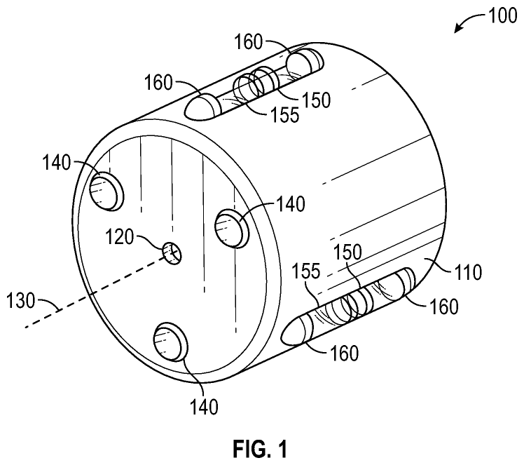

A detailed description of illustrative embodiments will now be described with reference to FIGS. 1-12. Although this description provides a detailed description of possible implementations, it should be noted that these details are intended to be exemplary and in no way delimit the scope of the inventive subject matter.

The laser plumb/pitch pipe alignment device described herein provides precise continuous straight line locations for boring plumb or pitched alignment holes through studs, walls, and roofs as well as for shooting a level line for pipe/conduit work. The device can be used both horizontally and vertically for exact alignment. In sample, configurations, the laser plumb/pitch pipe alignment device is designed to accommodate both typical 1½″ and 2″ polyvinylchloride (PVC) and acrylonitrile-butadiene-styrene (ABS) pipes. The design is a slip on and slips off fit connection that fits over the pipes to direct the laser light to the area for boring to accommodate the pipe extension or for plumb alignment. A sample design includes three button styled level vials on top for vertical plumb use and three elongated styled level vials that are set in recessed slots on the side of the device body for horizontal pitch/fall/level use. A sample configuration is a solid one piece design with no moving or mechanical parts other than the laser module retaining cap that closes the fixed laser module housing on the laser module that has been inserted.

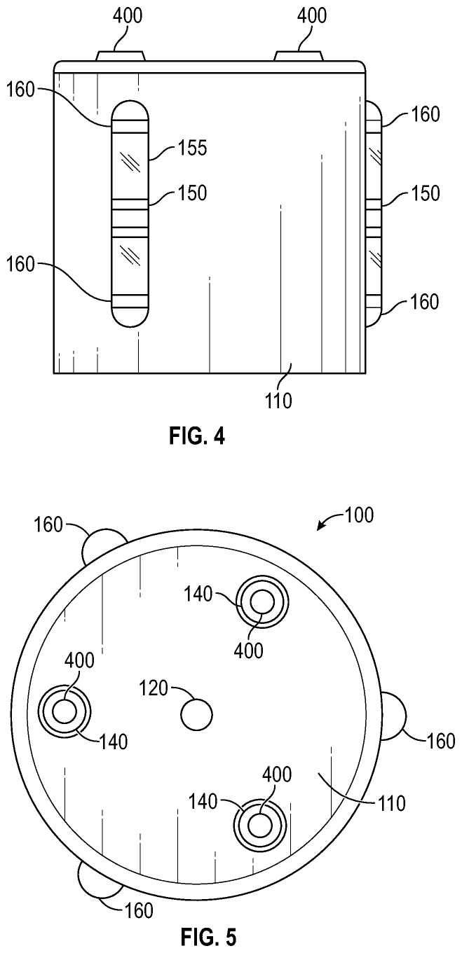

FIG. 1 is a perspective view of a laser plumb/pitch pipe alignment device 100 in a horizontal (pitch/fall/level) position in a sample configuration. The laser plumb/pitch pipe alignment device 100 includes a housing 110 that may be a solid piece formed of rigid plastic, wood, or metal, and the like. The housing 110 includes a center hole 120 at an end thereof that emits a laser light 130 from a laser module (not shown). At least one (e.g., three) round recessed slots 140 adapted to accept button styled level vials 400 (FIG. 4) may be disposed on the end of the housing 110 as shown for vertical plumb use. In addition, at least one (e.g., three) elongated styled level vials 150 may be disposed in corresponding recessed slots 155 between respective stops 160 on the side of the housing 110 as shown for horizontal pitch/fall/level use.

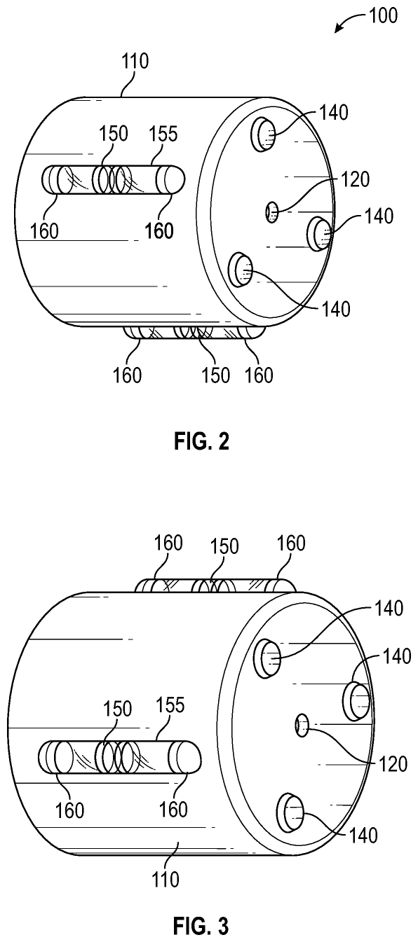

FIG. 2 provides a left side perspective view of the laser plumb/pitch pipe alignment device 100 in a vertical (plumb) position in a sample configuration, while FIG. 3 provides a right side perspective view of the laser plumb/pitch pipe alignment device 100 in a vertical (plumb) position in a sample configuration. FIG. 4 provides a side view of the laser plumb/pitch pipe alignment device 100 in a horizontal (pitch/fall/level) position in a sample configuration, while FIG. 5 provides a top view of the laser plumb/pitch pipe alignment device 100 in a sample configuration. FIGS. 4 and 5 show the button styled level vials 400 disposed in the round recessed slots 140.

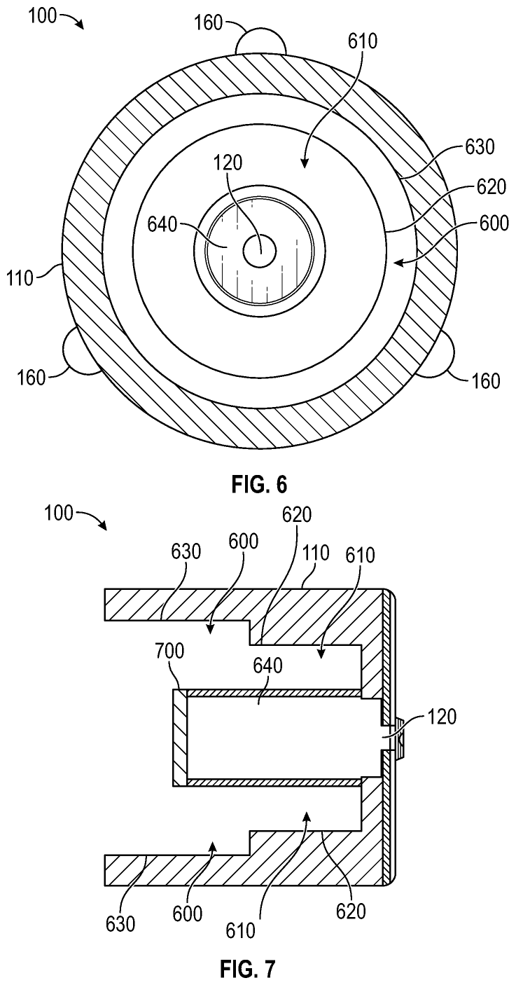

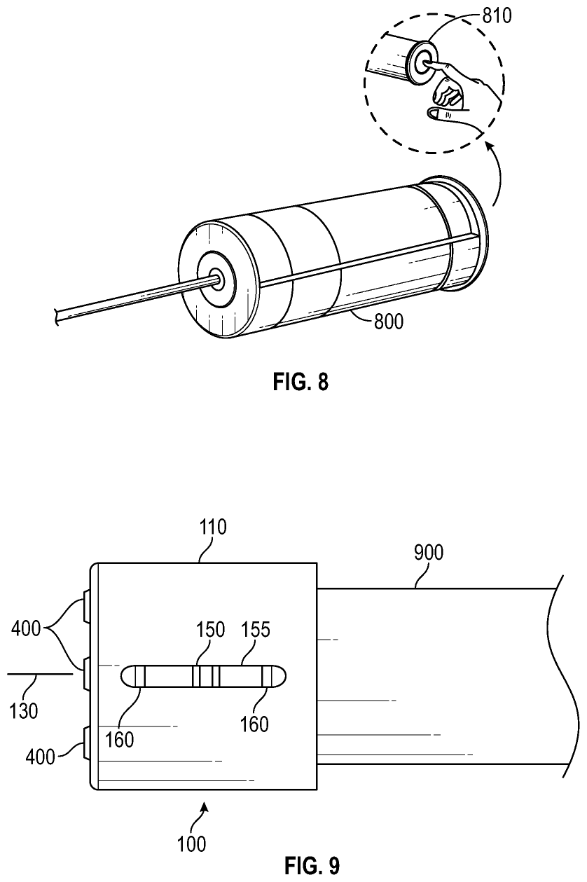

FIG. 6 is a bottom view of the laser plumb/pitch pipe alignment device 100 in a sample configuration. The bottom of the laser plumb/pitch pipe alignment device 100 is adapted to fit over pipe sections of different sizes (e.g., 1½″ and 2″ pipe sections in the sample illustrated). For this purpose, the housing 110 includes an outer stop 600 for the larger pipe (e.g., 2″) section and an inner stop 610 for the smaller pipe (e.g., 1½″) section. An inner wall 620 in the housing 110 separates the inner stop 610 from the outer stop 600 to provide a secure fitting of the 1½″ inserted pipe section when inserted to the inner stop 610. Similarly, an outer wall 630 in the housing 110 provides a secure fitting of the 2″ inserted pipe section when inserted to the outer stop 600. A laser module housing 640 (shown without a cap) is adapted to house the laser module 800 (FIG. 8) to enable the laser module 800 to emit laser light through the center hole 120.

FIG. 7 is a cross-sectional view of the interior of the laser plumb/pitch pipe alignment device 100 in a sample configuration. As shown, the laser plumb/pitch pipe alignment device 100 includes a laser module housing 600 that is sized and shaped to hold conventionally available laser modules 800. An end cap 700 may be screwed or snapped in place once the laser module 800 has been inserted.

FIG. 8 is a perspective view of a class IIIA laser module 800 with an on/off power switch 810 in a sample configuration. The laser module 800 is inserted into the laser module housing 640 whereby the laser light 130 emitted by the laser module 800 is aligned with the center hole 120 in the housing 110. Different laser modules 800 are readily available in the art. For example, the class IIIA laser module 800 may be a removable/replaceable self-contained 12 gauge bore sighting device that includes an internal battery that is operated with a push on-push off power switch 810. Such a laser module 800 is available from OTICAL (OTICAL 12GA Boresighter Red Dot Laser Bore Sight with ON/Off Switch—12 Gauge Class-IIIA Laser) and includes a class IIIA laser having an output power less than 5 mW using three LR44 batteries. Other similar devices may be used for the laser module 800.

FIG. 9 illustrates the laser plumb/pitch pipe device 100 mounted in a horizontal (pitch/fall/level) position on an end of a 1½″ pipe 900 for projecting a laser beam 130 to be used for alignment in a sample configuration. In this configuration, the 1½″ pipe 900 is inserted into the housing 100 until the 1½″ pipe abuts the inner stop 610 of the housing 100. The fit of the 1½″ pipe 900 against the inner stop 610 and inner wall 620 hold the 1½″ pipe 900 steady while providing proper alignment of the laser light 130 with the center axis of the 1½″ pipe 900.

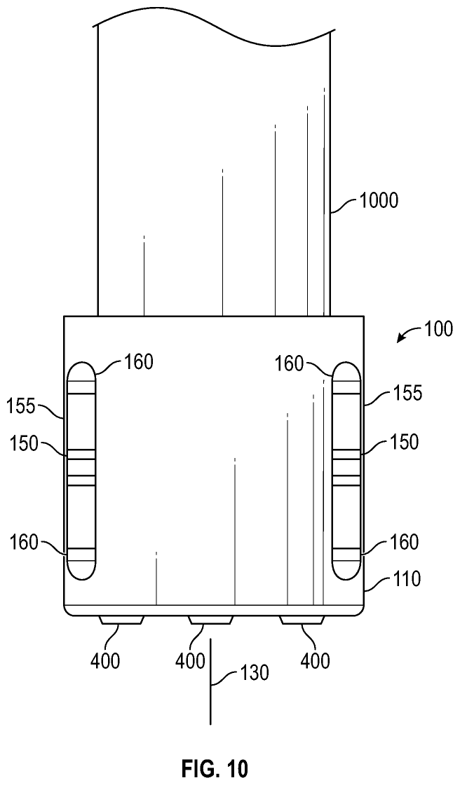

FIG. 10 illustrates the laser plumb/pitch pipe device 100 mounted in a vertical (plumb) position on an end of a 2″ pipe 1000 for projecting a laser beam 130 to be used for alignment in a sample configuration. In this configuration, the 2″ pipe 1000 is inserted into the housing 100 until the 2″ pipe 1000 abuts the outer stop 600 of the housing 100. The fit of the 2″ pipe 1000 against the outer stop 600 and outer wall 630 hold the 2″ pipe 1000 steady while providing proper alignment of the laser light 130 with the center axis of the 2″ pipe 1000.

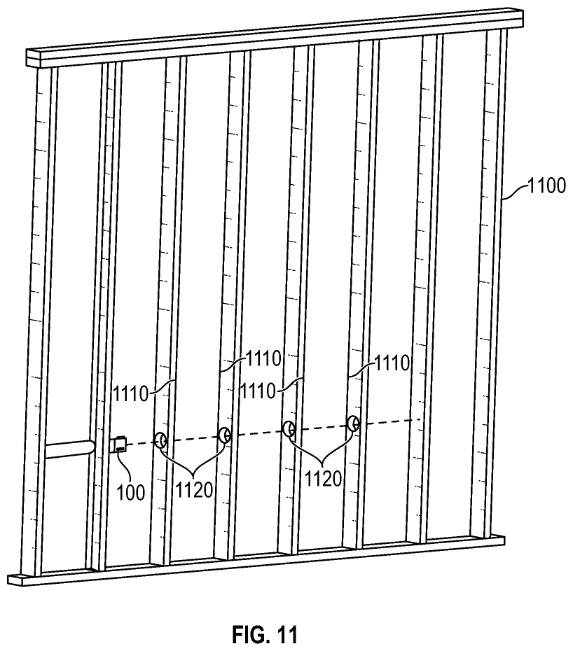

FIG. 11 illustrates a bare stud wall frame 1100 showing the laser plumb/pitch pipe alignment device 100 in a horizontal (pitch/fall/level) position with laser beam aligning points from the laser module 800 aligned with studs 1110 to drill out bore holes 1120 for pipe installation in a sample configuration. The aligning points show the center point for the boring drill for drilling 1½″ or 2″ boring holes 1120 for passing the pipes through the studs 1110.

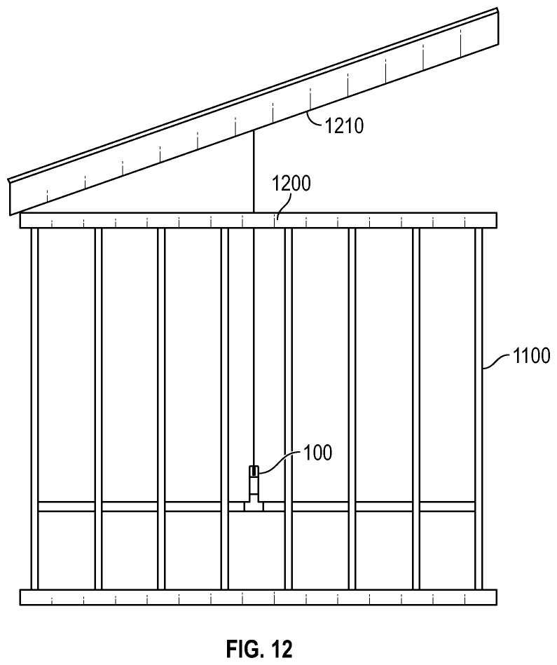

FIG. 12 illustrates a bare stud wall frame 1100 showing the laser plumb/pitch pipe alignment device 100 in a vertical (plumb) position with laser beam aligning points from the laser module 800 aligned with frame cap stud 1200 to drill out a bore hole for pipe installation through the frame cap stud 1200 all the way to the bottom side of a roof deck 1210 in a sample configuration. The aligning points show the center point for the boring drill for drilling 1½″ or 2″ boring holes for passing the pipes through the frame cap stud 1210 and optionally roof deck 1210.

It will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including.” “comprising,” or “having” and variations thereof herein is meant to encompass the items listed thereafter and equivalents thereof as well as additional items. Unless limited otherwise, the terms “connected.” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Although the present disclosure has been described with reference to specific features and embodiments thereof, it is evident that various modifications and combinations can be made thereto without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed:

1. A laser plumb/pitch pipe alignment device comprising:
A housing adapted to fit over an end of a pipe and having a center hole aligned with a center axis of the pipe when inserted; and
a laser module disposed within the housing so as to align with the center axis of the pipe, the laser module emitting laser light out of the center hole.

2. The laser plumb/pitch pipe alignment device of claim 1, wherein the housing has a first inner wall that abuts an outer surface of a pipe of a first size when inserted into the housing and a second inner wall that abuts an outer surface of a pipe of a second size, smaller than the first size, when inserted into the housing.

3. The laser plumb/pitch pipe alignment device of claim 1, further comprising at least one button styled level vial on an outer end of the housing for vertical plumb use.

4. The laser plumb/pitch pipe alignment device of claim 1, further comprising at least one elongated styled level vial set in a corresponding recessed slot on an outer side of the housing for horizontal pitch/fall/level use.

5. The laser plumb/pitch pipe alignment device of claim 1, wherein the housing includes a laser module housing that houses the laser module, the laser module housing having the center hole at one end thereof and a cap on another end thereof that is removable to provide access to the laser module when the laser module is housed within the laser module housing.

6. The laser plumb/pitch pipe alignment device of claim 1, wherein the laser module comprises a battery powered class IIIA laser module with an on/off power switch.

7. A method of providing precise continuous straight line locations for boring plumb or pitched alignment holes through at least one of studs, walls, or roofs and for shooting a level line for pipe/conduit work, comprising:
slipping a laser plumb/pitch pipe alignment device over an end of a pipe, the laser plumb/pitch pipe alignment device having a center hole aligned with a center axis of the pipe when inserted and a laser module disposed within a housing of the laser plumb/pitch pipe alignment device so as to align with the center axis of the pipe and to emit laser light out of the center hole; and
directing the laser light to an area for boring at least one hole to accommodate a pipe extension or for indicating a plumb line alignment point.

8. The method of claim 7, wherein the pipe has a first size, and wherein slipping the laser plumb/pitch pipe alignment device over the end of the pipe comprises inserting the pipe into the housing whereby an outer surface of the pipe abuts a first inner wall of the housing when inserted.

9. The method of claim 8, wherein the pipe has a second size smaller than the first size, wherein slipping the laser plumb/pitch pipe alignment device over the end of the pipe comprises inserting the pipe into the housing whereby an outer surface of the pipe abuts a second inner wall of the housing when inserted.

10. The method of claim 7, further comprising determining a vertical plumb using at least one button styled level vial on an outer end of the housing of the laser plumb/pitch pipe alignment device.

11. The method of claim 7, further comprising determining at least one of a horizontal pitch, fall, or level using at least one elongated styled level vial set in a corresponding recessed slot on an outer side of the housing of the laser plumb/pitch pipe alignment device.

12. The method of claim 7, further comprising inserting a laser module into a laser module housing within the housing of the laser plumb/pitch pipe alignment device whereby the laser module aligns with the center hole to emit the laser light out of the center hole when activated, and providing a cap on an end of the laser module housing opposite the center hole once the laser module has been inserted into the laser module housing.

13. The method of claim 12, wherein the laser module comprises a battery powered class IIIA laser module with an on/off power switch, further comprising turning the laser module on/off using the on/off power switch.
